(19) United States
(12) Patent Application Publication
(10) Pub. No.: US 2008/0217028 A1
(43) Pub. Date: Sep. 11, 2008

(54) Incineration Prevention Method and Arrangement

(76) Inventor: Samuel O'Neal Crumpton, Katy, TX (US)

Correspondence Address: HOUSTON OFFICE OF;NOVAK DRUCE AND QUIGG LLP, 1000 LOUISIANA STREET, FIFTY-THIRD FLOOR, HOUSTON, TX, 77002, US

(21) Appl. No.: 12/043,060

(22) Filed: Mar. 5, 2008

Related U.S. Application Data
(60) Provisional application No. 60/892,937, filed on Mar. 5, 2007.
(60) Provisional application No. 60/892,935, filed on Mar. 5, 2007.

(51) Int. Cl. A62C 2/10; A62C 3/02; E04B 1/94

(52) U.S. Cl. 169/48; 52/5; 160/39; 160/351

(57) ABSTRACT

A method and arrangement for providing an incineration prevention kit (10) for protecting an article (12) from wildfire and including multiple panels (20) constructed from flame retardant sheeting releasably interconnectable together into a protective sheath (25). At least one of the panels has an interconnected strap handle (30) that together with the panel, forms a closed loop (38). At least one of the multiple panels has an interconnector receiver (40) in the form of a grommet that is configured to be interconnected with the closed loop at least in the installed configuration (18). The strap handles (30) are formed by one or more elongate straps (32) interconnected with the panel (20) at a plurality of spaced apart connections (34) along the strap's length and the elongate straps (32) are arranged in a shape substantially the same as a perimeter (22) shape of the panel (20).

### CROSS REFERENCE TO RELATED APPLICATION(S)

The present application claims the benefit of U.S. Provisional Patent Application No. 60/892,935 filed Mar. 5, 2007 and expressly incorporates by reference the subject matter of that provisional application in its entirety into the present application.

### FIELD OF INVENTION

The present invention generally relates to covering a building or buildings or equipment, to include automobiles, to prevent involvement in surrounding wildfire.

### BACKGROUND

There have always been forest fires. Although in many ways they are beneficial to the land, when one comes through it can leave thousands of people homeless and bereft of all things in its wake that were flammable or would melt. When a wildfire approaches, people feel helpless. When there is a way for people to act and solve the problem, they should be provided the means.

Each year in California and the Northwest United States, wildfires claim hundreds of extremely expensive homes, costing the insurance industry and homeowners billions of dollars, in addition to those things that cannot be replaced.

Furthermore, fires in cities often spread to adjacent or nearby structures, compounding their destructiveness and danger to life and property.

Firefighters and professionals who work in high-heat environments routinely use fabrics that are impervious to fire up to very high temperatures. Furthermore, firefighters who work in wildfire areas carry flame-retardant blankets that allow them to cover up if they are unable to escape. These fires tend to burn over and burn out as their fuel is exhausted, so the firefighters find sufficient protection from flame-resistant blankets, so that they routinely survive exposure to the wildfire.

From U.S. Pat. No. 6,742,305 B2 for “FIRE PROTECTION COVER APPARATUS FOR STRUCTURES,” filed Oct. 18, 2002, issued Jun. 1, 2004, an arrangement is known that comprises an apparatus for permanent attachment to a structure, and from which a covering may be deployed in a manner similar to that of a room-darkening shade, and then secured, one piece to another. This arrangement differs significantly from the invention described herein in that the draping sheets contemplated herein are not permanently affixed to any structure or nearby apparatus, or attached to the structure. The invention contemplated herein is designed to be stored completely and deployed at the location, and is also designed to be usable in coverage of things other than buildings.

### SUMMARY

The hereunder described use of existing fire resistant materials contemplates a form usable to not only stop the destruction of a user's property in the event of a wildfire, but also be useful to fire fighters in preventing the spread of a fire beyond the building or buildings involved upon their arrival.

Protection from fire or wildfire need not be complicated or aesthetically repugnant. A homeowner should be allowed the peaceful enjoyment of his property without the appearance of constantly anticipating disaster.

It is commonly known that wild fires can come in quickly and with little warning. It is contemplated that a service may be provided to homeowners wherein the fire repellent sheets or panels may be stored nearby and rapidly deployed by professionals so the homeowner may concentrate on securing his or her belongings and departing the area. It is further contemplated that such professionals should be monitoring conditions as part of their service and be prepared at the first warning of approaching wildfire to deploy the instant protective arrangements in the service area nearest the fire first and continue covering all others who are under contract for provision of this service in all areas under threat.

The present invention involves using flame-resistant materials to cover existing structures, vehicles, and/or other property to prevent these things from being destroyed by wildfire. Although there have been inventions in the past whereby a homeowner could take flame-resistant materials and deploy them over his or her home from an apparatus that may or may not remain attached to the home, the present invention involves bringing these coverings to the home and applying them thereto.

It is anticipated that such a covering and such a service should be in demand among homeowners and insurance providers as a means of minimizing the incredible liability they face when a wildfire approaches. The present invention should serve to take the force out of the menace we call wildfire.

The invention will provide protection from radiant and convective heat associated with wildfire.

The invention will decrease the heat exposure of protected property so that covered property does not reach flash point temperatures while the property's covering is engulfed in flame.

The invention will decrease significantly the buffeting by winds associated with wildfire and protect the property from sustaining superficial damage associated with small flying debris.

The invention will be deployable upon property that has not been prepared in advance to receive the protection.

The invention will be removable and reusable.

The invention will be adaptable to various sizes and shapes of structures and property.

The invention will be usable by a homeowner if purchased or by professionals employed for its deployment.

The invention is in the form of sheets or panels of flame-resistant material with proven high-temperature durability, in layers that may include a reflective layer.

The invention panels will have an inner border made of flame-resistant fabric with sewn and loose areas forming handles.

The invention panels will be the same on both sides in order to be reversible and adaptable.

The invention panels will be laid on a structure, draping over the top, attached in an overlapping fashion to other invention panels so that substantially no flammable part of the underlying structure remains exposed. The overlapped invention panels will be secured at the ground to existing structure or to stakes sunk into the ground at intervals.

The invention panels are designed to be deployed only onto unoccupied property, not to serve to make a fire shelter out of a home or business.

The invention panels are to be attached to one another in an overlapping fashion in a preferred embodiment using short straps made of fire-resistant materials with hooks or carabiners at each end, securing the panels to one another.

Invention panels may be of varying size and shape to effect complete coverage of property of various kinds, sizes, and shapes.

### BRIEF DESCRIPTION OF THE DRAWINGS

FIG. 1 is a perspective view showing an article in the form of a private residence or house and that is susceptible to wildfire.

FIG. 2 is a perspective view showing the same house wrapped in a flame-retardant sheath configured according to the present invention.

FIG. 3 is a plan view depicting a plurality of flame retardant panels interconnectable to form the protective sheath of FIG. 2.

FIG. 4 is a perspective view detailing an exemplary panel of the invention.

FIGS. 5A and 5B illustrate an interconnector in the form of a carabiner-style fastener in closed and open configurations, respectively.

FIG. 6 is a perspective view showing a pair of exemplarily interconnected panels.

FIGS. 7A and 7B are perspective views showing a pair of panels interconnected using elongate belts, the lengths of which are reduced between the initial stage of interconnection (FIG. 7A) and a cinched-up or reduced-length configuration where the two panels are overlapping (FIG. 7B).

FIG. 8 is a perspective view illustrating a kit configured according to the present invention packaged into the stored configuration.

### DETAILED DESCRIPTION

The contemplated design and use of covering materials for protecting various types of property will be described including the following considered embodiments and the preferred embodiment.

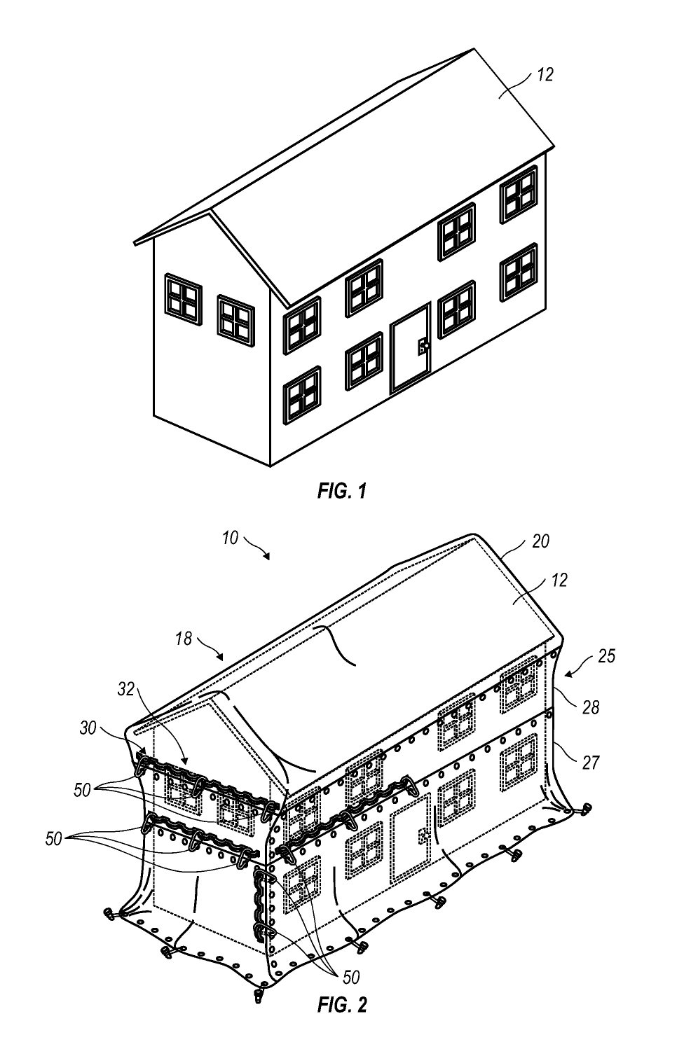

Referring to FIG. 1, a structure, such as a private residence, is shown illustrating an article (12) susceptible to destructive incineration, particularly by wildfire. Other exemplary articles include automobiles, construction equipment and the like.

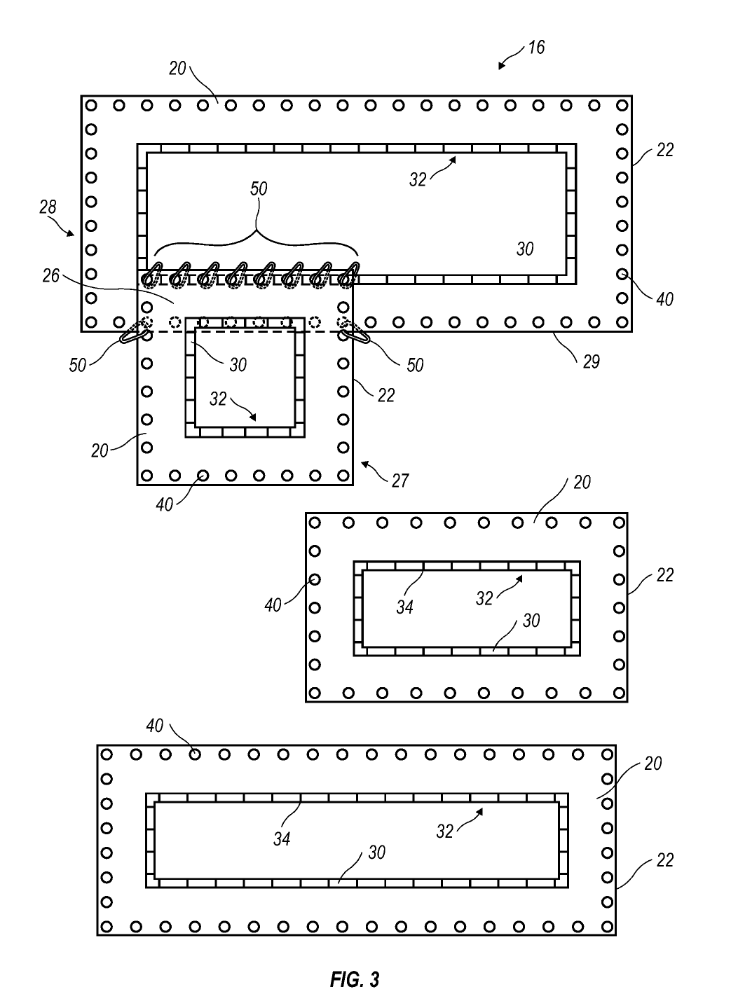

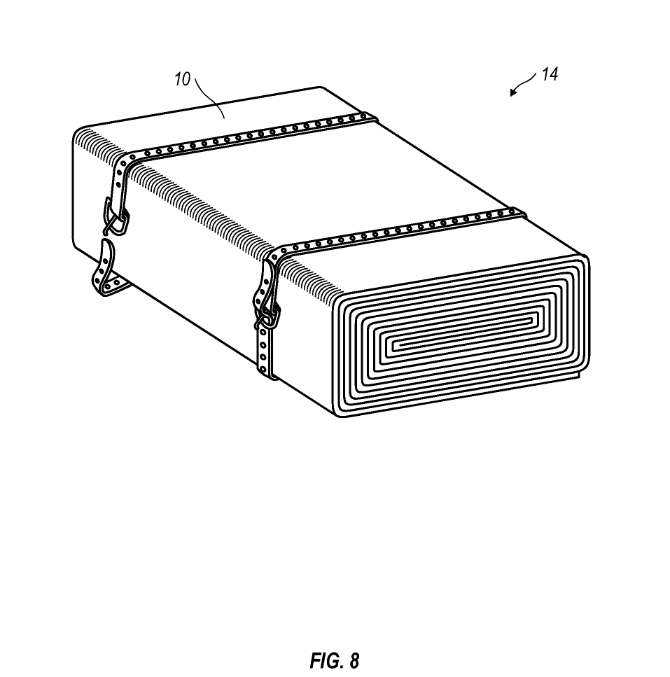

In FIG. 2 an incineration prevention kit (10) for protecting such an article (12) from wildfire is shown and that is capable of being placed in at least a stored configuration (14) as depicted in FIG. 8, a deployment configuration (16) as depicted in FIG. 3 and an installed configuration (18) as depicted in FIG. 2.

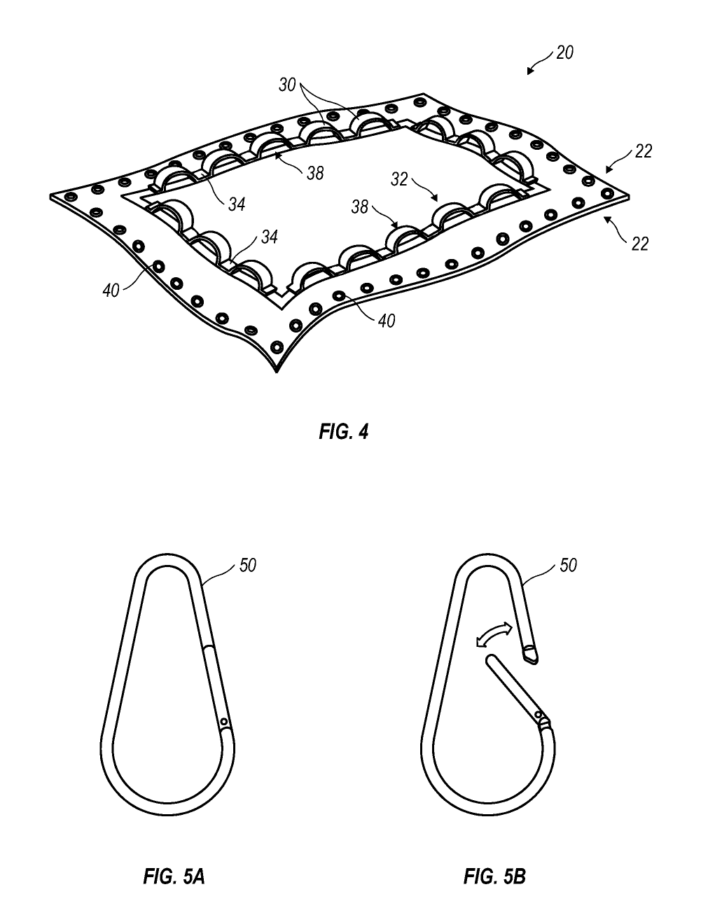

As can be best appreciated between FIGS. 2 and 3, the kit (10) comprises (includes, but is not necessarily limited to) multiple panels (20) constructed from flame retardant sheeting that are releasably interconnectable together into a protective sheath (25) for a target article that is susceptible to incineration. At least one of the panels has a strap handle (30) interconnected therewith and the strap handle (30), together with the panel (20), forms a closed loop (38). Furthermore, at least one of the multiple panels (20) has an interconnector receiver (40), exemplarily in the form of a grommet, configured to be interconnected with the closed loop (38) at least in the installed configuration (18), but also during deployment, before installation. As can be appreciated in at least FIGS. 3, 4 and 6, a plurality of grommet holes (40) are arranged along and proximate to a perimeter (22) of the respective panels (20).

As illustrated in FIGS. 3, 4 and 6, each of the multiple panels (20) has at least one strap handle (30) interconnected therewith and which, together with the panel, forms a closed loop (38). Preferably, each of the multiple panels (20) has a plurality of strap handles (30) interconnected therewith as shown and the plurality of strap handles (30) form at least a pair of graspable hand-holds for an installer in the deployment configuration (16).

In a preferred embodiment, a plurality of strap handles (30) are formed by an elongate strap (32) interconnected with the respective panel (20) at a plurality of spaced apart connections (34) along a length thereof. Exemplarily, the strap may be constructed from woven belting that is secured to the particular panel by stitching or otherwise attaching the belting to the panel (20) at intervals along the length of the strap (32) as depicted in at least in FIG. 3.

For ease in manufacturing, it is contemplated that the strap handles (30) on a particular panel (20) can be formed using a plurality of elongate straps (32) that are each interconnected with the respective panel (20) at a plurality of spaced apart connections (34). As shown, in a preferred configuration, the elongate straps (32) are arranged on the respective panel (20) in a shape substantially the same as the perimeter (22) shape of the panel (20). As shown in FIG. 3, the panels (20) are rectangularly shaped and the straps (32) that form the handles (30) are arranged as a reduced-size rectangle on the panel (20). To facilitate interconnection between panels (20), it is preferred that the spacing distance between the perimeter (22) of a panel (20) and its corresponding strap handles (30) be uniform between the several panels (20) of the kit (10).

In at least one embodiment, one or more of the panels (20) of the kit (10) has a plurality of strap handles (30) on each of two sides of the panel (20); preferably with each of the two sides being similarly configured.

In one embodiment, a majority of the multiple panels (20) constituting the incineration prevention kit (10) have substantially identical sizes. In another embodiment, the incineration prevention kit (10) has at least a quarter of its multiple panels (20) being of substantially identical sizes.

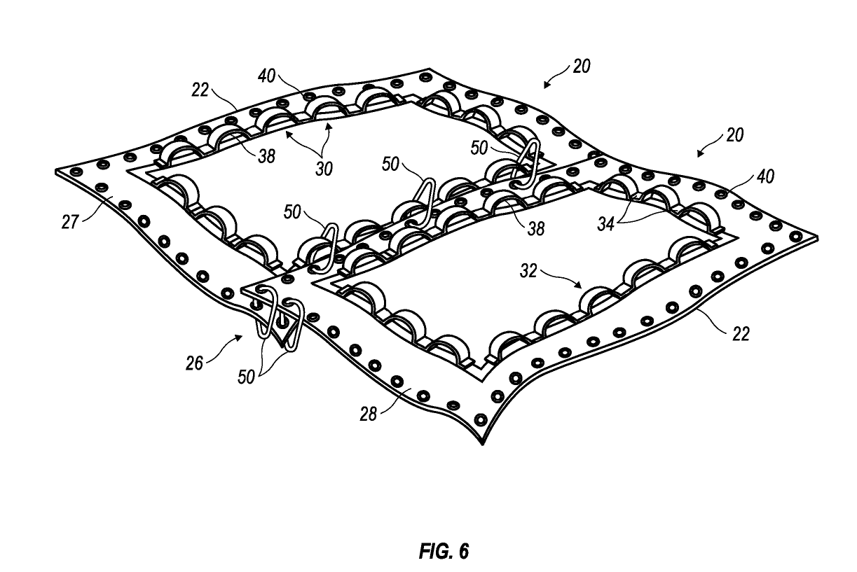

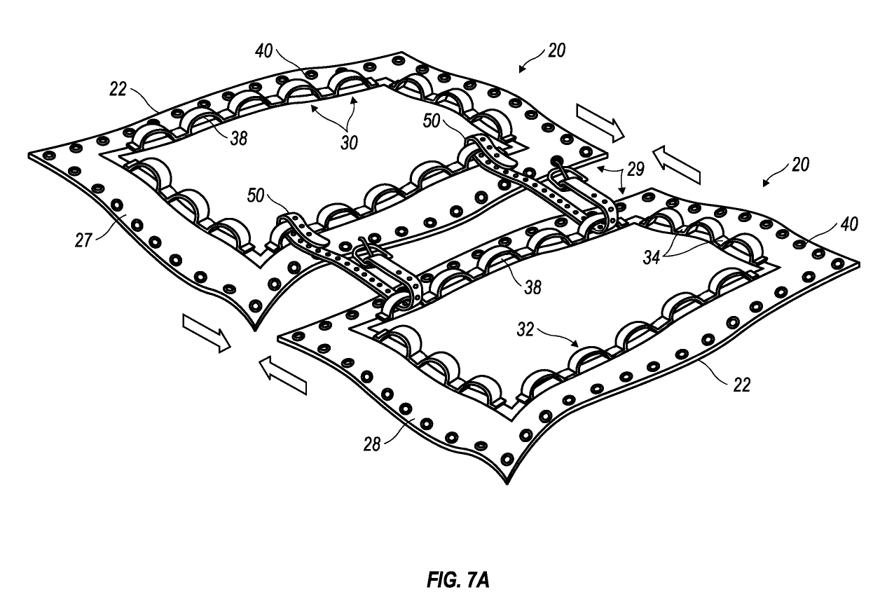

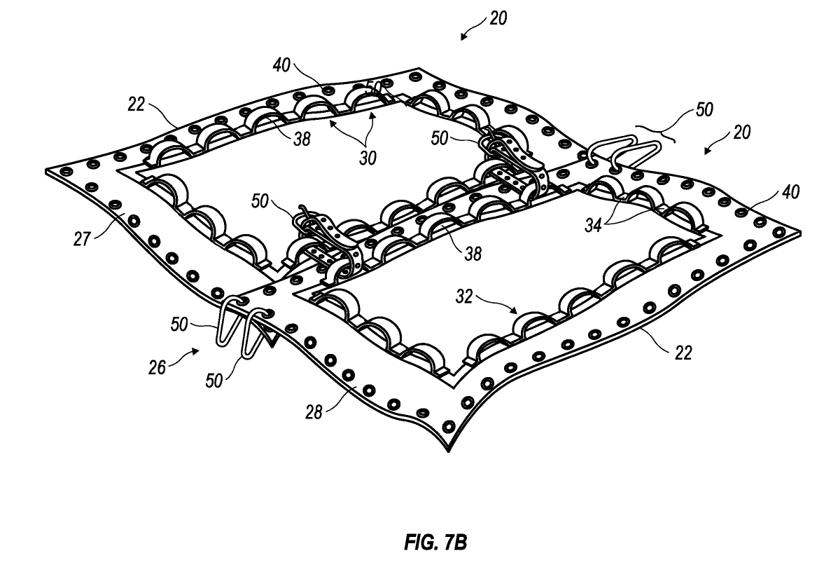

FIGS. 5A and 5B illustrate an interconnector (50) in the form of a carabiner-style fastener hooked between an interconnector receiver (40) of a first panel and a strap handle (30) of a second panel in an installed configuration (18) as shown in the upper left portion of FIG. 3 and FIG. 6 where a pair of panels (20) are secured relative one another in an overlapping orientation. The pair of overlapping panels (20) has an overlap zone (26) along an edge (29) of each of the pair of panels. As shown, the overlap zone (26) is elongate and substantially horizontally oriented in the installed configuration (18). FIGS. 7A and 7B show a configuration similar to that of FIG. 6 except that the interconnector (50) between the panels (20) takes the form of an adjustable belt, the length of which is reduced in order to cinch the adjacent panels (20) together during deployment.

Referring to FIG. 2, the sheath (25) of interconnected panels (20) is shown installed about the at-risk structure/article (12). As shown in FIGS. 2 and 3, one of the pair of overlapping panels (20) is an exterior panel (27) at the overlap zone (26) and the other of the pair of overlapping panels is an interior panel (28) at the overlap zone (26). Referring particularly to FIG. 2, the exterior panel (27) of overlapping panels (20) is lower than the interior panel (28) in the installed configuration (18). Still further, a top portion of the exterior panel (27) overlaps a bottom portion of the interior panel (28) in the installed configuration (18). As shown, the top portion of the exterior panel (27) overlaps the bottom portion of the interior panel (28) for a vertical distance of at least half of a foot in the installed configuration (18) in one embodiment and for a vertical distance of at least one foot in the installed configuration (18) in an alternative embodiment.

In FIG. 2, the top panel (20) because of its larger size can suitably be a panel that is draped over the roof of a structure (12) with side-skirt panels (20) suspended therefrom.

It should also be appreciated that the unique panel configurations described herein are considered independent inventions, as are the methods conducted as described herein for protecting incineration-susceptible articles such as houses, automobiles and the like.

It is also contemplated that the sheets or panels (20) of fire resistant material can be joined together either before or after deployment on the structure (12) or other property covered and then using the straps and/or hooks (50) configure the sheath (25) to the article's shape. This method would be convenient, in that an installer would not need to carry on his/her person the attaching straps.

Another possible embodiment of the contemplated design includes panels (20) that may be secured to one another by means of hook and loop fabric. In this embodiment, the panels (20) can be attached to one another very quickly and in infinitely variable relationships to one another.

Another possible embodiment of the contemplated design is that of using rope or cord and lacing panels (20) together at their junctions.

In a preferred embodiment, the sheets or panels (20) are constructed from fire retardant material such as Nomex® or Nomex® Kevlar®. Optionally, a second inner tier of handles can be included that are farther from the edge of the panel (20) than the first in order to increase versatility in conforming the drapes to odd shapes or different applications.

In a preferred embodiment, it is contemplated that the panels (20) can advantageously be of a size of about three meters by five meters so that they are small enough to store, but would make short work of covering a house or structure 12. Most of the panels (20) are contemplated to be of a rectangular shape with some in a trapezoidal shape with two ninety degree angles on one end and the opposite end to describe a typical gable angle, some in a pentagonal arrangement with two ninety degree angles on one end and three angles on the other end corresponding to a typical home gable arrangement.

It is contemplated that under some circumstances, the creative use of longer straps may be preferred when used by someone skilled in the art in order to cover irregularly shaped or roofed structures as exemplified between FIGS. 7A and 7B. It is further contemplated that the reinforced holes (40) on the edges and the fabric handles (30) on the panels (30) should be large enough in every case so that they may accommodate up to four hooks used with the described straps (50).

Also within the preferred embodiment, it is contemplated that vehicles (12) with tires should be driven on top of one or more panels (20) in order to completely protect the property by being completely covered. However, a form-fit is not necessary.

1. An incineration prevention kit (10) for protecting an article (12) from wildfire and having at least a stored configuration (14), a deployment configuration (16) and an installed configuration (18), said kit comprising:
multiple panels (20) constructed from flame retardant sheeting releasably interconnectable together into a protective sheath (25) for an article susceptible to incineration;
at least one of said multiple panels having a strap handle (30) interconnected therewith and said strap handle, together with said panel, forms a closed loop (38); and
at least one of said multiple panels having an interconnector receiver (40) configured to be interconnected with said closed loop at least in the installed configuration (18).

2. The incineration prevention kit (10) as recited in claim 1, wherein a plurality of said multiple panels (20) each has at least one strap handle (30) interconnected therewith and which, together with said panel, forms a closed loop (38).

3. The incineration prevention kit (10) as recited in claim 1, wherein at least one of said multiple panels (20) has a plurality of strap handles (30) interconnected therewith, said plurality of strap handles (30) constituting at least a pair of graspable hand-holds for an installer in the deployment configuration (16).

4. The incineration prevention kit (10) as recited in claim 3, wherein a plurality of said multiple panels (20) each has a plurality of strap handles (30) formed by an elongate strap (32) interconnected with the respective panel (20) at a plurality of spaced apart connections (34) along a length thereof.

5. The incineration prevention kit (10) as recited in claim 3, wherein a plurality of said multiple panels (20) each has a plurality of strap handles (30) formed by a plurality of elongate straps (32) interconnected with the respective panel (20) at a plurality of spaced apart connections (34), said elongate straps (32) arranged on the respective panel (20) in a shape substantially the same as a perimeter (22) shape of the panel (20).

6. The incineration prevention kit (10) as recited in claim 3, wherein a plurality of said multiple panels (20) each has a plurality of strap handles (30) on each of two sides thereof, said strap handles (30) formed by an elongate strap (32) interconnected with the respective panel at a plurality of spaced apart connection (34).

7. The incineration prevention kit (10) as recited in claim 1, wherein a majority of said multiple panels (20) have substantially identical sizes.

8. The incineration prevention kit (10) as recited in claim 1, wherein at least a quarter of said multiple panels (20) have substantially identical sizes.

9. The incineration prevention kit (10) as recited in claim 1, further comprising an interconnector (50) fastened between an interconnector receiver (40) of a first panel and a strap handle (30) of a second panel in an installed configuration (18).

10. The incineration prevention kit (10) as recited in claim 1, wherein a pair of the multiple panels (20) are secured relative one another in an overlapping orientation in the installed configuration (18).

11. The incineration prevention kit (10) as recited in claim 10, wherein the pair of overlapping panels (20) has an overlap zone (26) along an edge (29) of each of the pair of panels.

12. The incineration prevention kit (10) as recited in claim 11, wherein the overlap zone (26) is elongate and substantially horizontally oriented in the installed configuration (18).

13. The incineration prevention kit (10) as recited in claim 12, wherein one of the pair of overlapping panels (20) is an exterior panel (27) at the overlap zone (26) in the installed configuration (18) and the other of the pair of overlapping panels is an interior panel (28) at the overlap zone (26) in the installed configuration (18).

14. The incineration prevention kit (10) as recited in claim 13, wherein the exterior panel (27) of the pair of overlapping panels (20) is lower than the interior panel (28) in the installed configuration (18).

15. The incineration prevention kit (10) as recited in claim 13, wherein a top portion of the exterior panel (27) overlaps a bottom portion of the interior panel (28) in the installed configuration (18).

16. The incineration prevention kit (10) as recited in claim 15, wherein the top portion of the exterior panel (27) overlaps the bottom portion of the interior panel (28) for a vertical distance of at least half of a foot in the installed configuration (18).

17. The incineration prevention kit (10) as recited in claim 15, wherein the top portion of the exterior panel (27) overlaps the bottom portion of the interior panel (28) for a vertical distance of at least one foot in the installed configuration (18).

18. The incineration prevention kit (10) as recited in claim 1, wherein said interconnector receiver (40) is a grommet hole through the respective panel (20).

19. The incineration prevention kit (10) as recited in claim 18, further comprising a plurality of said multiple panels (20) each having a plurality of grommet holes (40) arranged along and proximate to a perimeter (22) of the respective panel (20).
